(19) United States
(12) Patent Application Publication
(10) Pub. No.: US 2007/0027996 A1
(43) Pub. Date: Feb. 1, 2007

(54) Configuring application settings based on changes associated with a network identifier

(75) Inventor: John-Paul M. Stewart, Redmond, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/195,570

(22) Filed: Aug. 1, 2005

(51) Int. Cl. G06F 15/16

(52) U.S. Cl. 709/230

(57) ABSTRACT

Application settings of a network device may be dynamically configured based on a network identifier of the network to which the network device is connected. For example, a value of an application setting specifying a proxy server and/or a firewall client may be automatically set based on the current NLA GUID of the network to which a user device is connected. The user device may register with a network service so that the application is notified of any changes to network characteristics associated with a network identifier. In response to receiving such notifications, any application settings affected by these changes may be updated on the user device. The values of application settings for particular networks may be stored in a database or other type of data structure available to the user device (e.g., stored on the user device itself), which may be automatically updated in response to such notifications.

### BACKGROUND

Laptop users and users of other mobile user devices often use these devices on different networks at different times. Certain settings of these devices are (at least initially) configured for use on a particular network. For example, settings on a corporate laptop may be configured to use a corporate proxy server and firewall client available on the corporation's enterprise network. However, when such mobile user devices are moved and connected to another network, the settings often are not valid for the network. In such cases, a user must determine the identity of the network and the proper settings for this network, and then manually enter these values for the application. This process must be repeated each time the user changes networks. Further, the user must manually update the values of these settings if these values change for a network while the user device is connected to it.

Further, a user device often is connected to multiple (logical) networks simultaneously, and each of these networks may have different values for different network settings. Accordingly, when the user switches between networks, the user must manually re-set the application settings accordingly.

### SUMMARY

This Summary provides an illustrative context for aspects of the invention, in a simplified form. It is not intended to be used to determine the scope of the claimed subject matter, nor to identify key and/or essential features of the claimed subject matter. These and other aspects of the invention are described more fully below in the Detailed Description.

Application settings of a user device may be dynamically configured based on a network identifier of the network to which the user device is connected. For example, a value of an application setting specifying a proxy server and/or a firewall client for an application such as, for example, Microsoft® Internet Explorer, may be automatically set based on the current Network Layer Awareness (NLA) Globally Unique Identifier (GUID) (i.e., the NLA signature) of the network to which a user device is connected. The application may be registered with a network service (e.g., an NLA service) on the user device (e.g., provided by the operating system) so that the application is notified of any changes to network characteristics associated with a network identifier (e.g., an NLA GUID). In response to the application receiving such notifications from the network service, any application settings affected by these changes may be updated on the user device.

The values of application settings for particular networks may be stored in a database or other type of data structure available to the user device (e.g., stored on the user device itself). This database may be automatically updated in response to notifications that indicate changes to network characteristics associated with a network identifier such as, for example, an NLA GUID.

A user interface (e.g., a GUI) may be provided that enables a user to view, add, modify and/or delete values of application settings corresponding to a network identifier. The user interface may read these values from, and store these values to, a database or other type of data structure available to the user device.

In an embodiment of the invention, one or more settings of an application on a network device are configured. A data structure including one or more entries is stored on a computer-readable medium, at least a first entry defining a relationship between a value of a first setting of the application and a network identifier specifying a particular communications network. The setting represents a parameter of the network.

In an aspect of this embodiment, a notification is received from a network service on the network device. The notification specifies the network identifier and specifies a change to a second setting associated with the network identifier, and the second setting represents a same parameter as the first setting. In response to receiving the notification, the value of the first setting of the first entry is updated in accordance with the specified change.

In another aspect of this embodiment, the application is registered to receive notifications from the network service of changes to values of settings associated with the network identifier.

In another aspect of this embodiment, a user interface is provided that enables a user to specify a change of the value of the first setting of the application. In response to the user specifying the change, the value of the first setting of the first entry is updated in accordance with the specified change.

In yet another aspect of this embodiment, the application is controlled to apply the value of the setting.

In another aspect of this embodiment, the network identifier is a globally-unique identifier defined in accordance with a version of Network Layer Awareness technology.

In another aspect of this embodiment, the first setting is an identification of a proxy server.

In yet another aspect of this embodiment, the first setting is an identification of a firewall client.

In another embodiment of the invention, a computer program product is provided. The product includes a computer-readable medium, and computer-readable signals stored on the computer-readable medium defining instructions that, as a result of being executed by a computer, instruct the computer to perform the method of the embodiment of the invention described in the preceding paragraphs and/or one or more aspects thereof described in the preceding paragraphs.

In another embodiment of the invention, a system for configuring one or more settings of an application on a network device is provided. A data structure including one or more entries is stored on a computer-readable medium, at least a first entry defining a relationship between a value of a first setting of the application and a network identifier specifying a particular communications network, the setting representing a parameter of the network.

In an aspect of this embodiment, the system includes a user-initiated changes component operative to enable a user to specify a change of the value of the first setting of the application, and to update, in response to the user specifying the change, the value of the first setting of the first entry in accordance with the specified change.

In another aspect of this embodiment, a network-initiated changes component is operative to receive a notification from a network service on the network device. The notification specifies the network identifier and specifies a change to a second setting associated with the network identifier. The second setting represents a same parameter as the first setting. The network-initiated changes component is operative to update, in response to receiving the notification, the value of the first setting of the first entry in accordance with the specified change.

In another aspect of this embodiment, the network-initiated changes component is operative to register the application to receive notifications from the network service of changes to values of settings defined for the network identifier.

In yet another aspect of this embodiment, the user-initiated changes component is operative to control the application to apply the value of the setting.

In another aspect of this embodiment, the network identifier is a globally-unique identifier defined in accordance with a version of Network Layer Awareness technology.

In another aspect of this embodiment, the first setting is an identification of a proxy server.

In another aspect of this embodiment, the first setting is an identification of a firewall client.

In another embodiment of the invention, a computer-readable medium having computer-readable signals stored thereon is provided. The computer-readable signals define a data structure corresponding to a network device on a communications network. The data structure includes at least a first entry defining a relationship between a value of a setting of an application and a network identifier specifying a particular communications network.

In an aspect of this embodiment, at least the first entry includes: the network identifier; an application identifier specifying the application; a setting identifier specifying the setting; and the value of the setting.

In another aspect of this embodiment the network identifier is a globally-unique identifier defined in accordance with a version of Network Layer Awareness technology.

In yet another aspect of this embodiment, the setting is an identifier of a proxy server.

In another aspect of this embodiment, the setting is an identifier of a firewall client.

In another aspect of this embodiment, at least one of the entries includes a user identifier specifying a user of the network device, such that the at least one entry only applies to the specified user.

Other advantages, novel features, and objects of the invention, and aspects and embodiments thereof, will become apparent from the following detailed description of the invention, including aspects and embodiments thereof, when considered in conjunction with the accompanying drawings, which are schematic and which are not intended to be drawn to scale. In the figures, each identical or nearly identical component that is illustrated in various figures is represented by a single numeral. For purposes of clarity, not every component is labeled in every figure, nor is every component of each embodiment or aspect of the invention shown where illustration is not necessary to allow those of ordinary skill in the art to understand the invention.

### BRIEF DESCRIPTION OF THE DRAWINGS

FIG. 1 is a block diagram illustrating an example of a user device for configuring one or more application settings based on changes associated with a network identifier, according to some embodiments of the invention;

FIG. 2 is a block diagram illustrating an example of a database for storing values of application settings for particular networks, according to some embodiments of the invention;

FIG. 3 is a diagram illustrating an example of a database schema for storing values of application settings for particular networks, according to some embodiments of the invention;

FIG. 4 is a screen shot illustrating an example of a user interface display for viewing, adding, modifying and/or deleting values of application settings for particular networks, according to some embodiments of the invention;

FIG. 5 is a flow chart illustrating an example of a method of modifying values of application settings based on changes associated with a network identifier, according to some embodiments of the invention;

FIG. 6 is a flow chart illustrating an example of a method of modifying values of application settings associated with a network identifier based on changes specified by a user, according to some embodiments of the invention;

FIG. 7 is a block diagram illustrating an example of a computer system on which some embodiments of the invention may be implemented; and

FIG. 8 is a block diagram illustrating an example of a storage system that may be used as part of the computer system to implement some embodiments of the invention.

### DETAILED DESCRIPTION

Although some embodiments of the invention are described in relation to use of an NLA GUID (e.g., NLA signature), it should be appreciated that the invention is not so limited. Other types of network identifiers may be used, and are intended to fall within the scope of the invention. Further, although some embodiments of the invention are described in relation to Microsoft® Internet Explorer, it should be appreciated that the invention is not so limited. Embodiments of the invention may be implemented for any application having network-dependent settings. For example, embodiments of the invention may be implemented using MSN Messenger, Microsoft Outlook anti-virus software, firewall applications, network access/security applications, other applications (including non-Microsoft applications) or any suitable combination of the foregoing. In addition, although some embodiments of the invention are described in relation to settings for proxy servers and firewall clients (e.g., ISA Firewall Client), the invention is not so limited. Embodiments of the invention may be implemented for any network-dependent setting, such as, for example, Windows® firewall, Windows® printer, other settings (including non-Windows® settings), including any of those disclosed herein, or any suitable combination of the foregoing.

The function and advantage of these and other embodiments of the present invention will be more fully understood from the examples described below. The following examples are intended to facilitate a better understanding and illustrate the benefits of the present invention, but do not exemplify the full scope of the invention.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, shall be closed or semi-closed transitional phrases, as set forth, with respect to claims, in the United States Patent Office Manual of Patent Examining Procedures (Eighth Edition, Revision 2, May 2004), Section 2111.03.

### EXAMPLES

Some embodiments of the invention are directed to changing a value of an application setting based on a change of a network characteristic associated with a globally-unique identifier (GUID) provided by a Network Layer Awareness (NLA) service. An NLA GUID is often referred to as an NLA signature. An NLA GUID or signature may be configured in any of the variety of ways such as, for example: Network ID|link ID|hop ID, in which the network ID may be a connection DNS suffix, the link ID may be a MAC address and the hop ID may be a basic service set ID of a wireless network. Such a GUID may have any of a variety of lengths such as, for example, forty-eight bytes. Other types of GUIDs may be used. The NLA service may be configured as part of an operating system on a network device (e.g., a user device). The operating system may be any of a plurality of types of operating systems such as, for example, any of a variety of operating systems available from Microsoft, such as those disclosed herein. The operating system also may provide an NLA API, which enables applications to interface with the NLA service. For example, users may utilize the NLA API to develop applications that use the NLA service.

An NLA service aggregates network information on behalf of applications and enables them to easily and effectively adapt to changing environments. For each network to which a user device is connected, NLA aggregates the network information available to the user device and generates a GUID to identify the network. Applications can query the NLA service for this list of GUIDs and the network characteristics associated with the networks the GUIDs identify. These network characteristics may include, but are not limited to: managed; bandwidth; internet connectivity; primary DNS suffix; DC authenticated; host IP address; subnet mask; subnet IP address; default gateway IP address; Windows Internet Name Service (WINS); proxy server; firewall client; other network characteristics; or any suitable combination of the foregoing.

A managed characteristic indicates whether the network device is managed by a domain controller. A bandwidth characteristic indicates the bandwidth of a TCP connection. An internet connectivity characteristic indicates the existence of a connection to the Internet. A primary DNS suffix indicates the name of the domain for which the network device is a member or the DNS suffix of the network device's full network device name. A DC authenticated characteristic indicates the domain controller (DC) of the domain for which the user device is a member and has authenticated the user device. A host IP address characteristic indicates the IP address of the user device. A subnet mask characteristic indicates the subnet mask of the subnet to which the user device is connected. A subnet IP address indicates the network ID of the subnet to which the user device is connected. A default gateway IP address indicates the IP address of the default gateway. A WINS characteristic indicates whether the user device is connected to a network on which a WINS server is present. It should be appreciated that the WINS characteristic would only apply to user devices configured with one of the operating systems available from a Microsoft Corporation described below. A proxy server characteristic indicates the proxy server to be used by the user service, and the firewall client indicates the firewall client to be used by the user device. NLA service, including the use of an NLA GUID, is described in more detail on the Microsoft Developers Network, which on the date of the filing of this application is located at: http://msdn.microsoft.com. For example, Longhorn Network Location Awareness Service by Tracey Yao et al., available on the Microsoft Developer Network, describes the use of an NLA GUID for the anticipated release of the operating system codenamed Longhorn by Microsoft Corporation.

Thus, it should be appreciated that, in some embodiments of the invention, the network ID (e.g., a GUID) is an identifier for an aggregation of network information, including any of the network characteristics described herein, that are available to one or more user devices on a network.

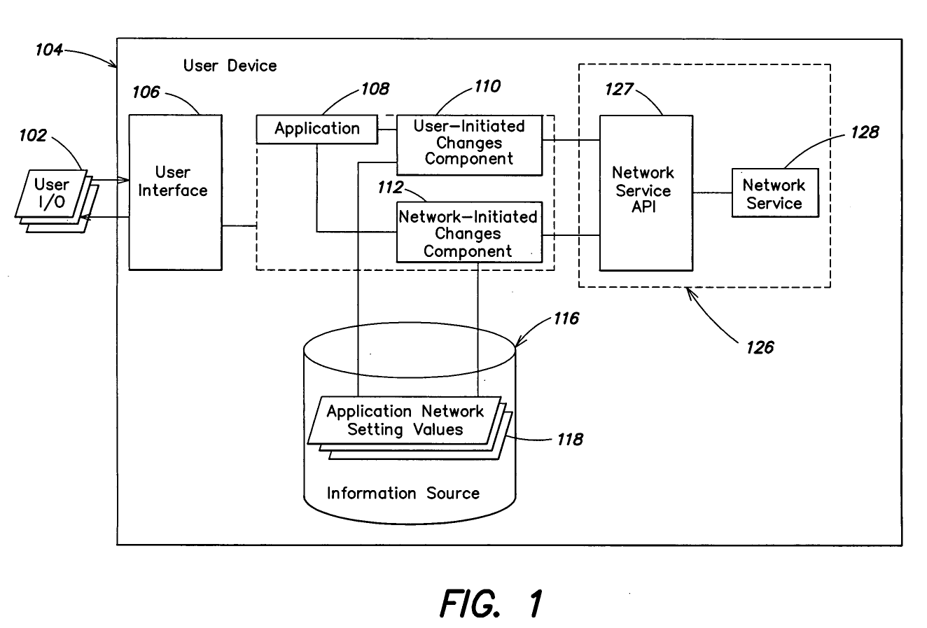

FIG. 1 is a block diagram illustrating an example of a user device 104 for configuring one or more application settings based on changes associated with a network identifier, according to some embodiments of the invention. User device 104 is merely an illustrative embodiment of a user device for configuring one or more application settings based on changes associated with a network identifier, and is not intended to limit the scope of the invention. Any of numerous other implementations of such a user device, for example, variations of user device 104, are possible and are intended to fall within the scope of the invention.

User device 104 may be connected to one or more networks. As used herein, a “network” is a group of two or more components interconnected by one or more segments of transmission media on which communications may be exchanged between the components. Each segment may be any of a plurality of types of transmission media, including one or more electrical or optical wires or cables made of metal and/or optical fiber, air (e.g., using wireless transmission over carrier waves) or any combination of these transmission media. As used herein, “plurality” means two or more. It should be appreciated that a network may be as simple as two components connected by a single wire, bus, wireless connection, or other type of segments. Further, it should be appreciated that when a network is illustrated in a drawing of this application as being connected to an element in the drawing, the connected element itself is considered part of the network.

As used herein, a “network device” is a device operative to communicate on a network, including, but not limited to: workstations, personal computers, terminals, laptop computers, end stations, user devices, servers, gateways, registers, switches, routers, hubs, bridges, directories, transmitters, receivers, repeaters, and any combinations thereof. As used herein, a “user device” is a network device from/to which a user may send/receive communications, and which may serve as an endpoint to communications on a communications network. User devices include, but are not limited to: workstations; personal computers (e.g., PCs); laptop computers, notebook computers; telephones (e.g., landline or mobile); pagers; Blackberry™ brand devices, PCS devices, personal digital assistants (PDAs), two-way radios (e.g., “walkie-talkies”), other types of user devices, and any suitable combination of the foregoing.

A network may be any of a variety of types of network including, but not limited to, a local area network (LAN), a metropolitan area network (MAN), a wide-area network (WAN), a wireless network, another type of network, or any suitable combination of the foregoing.

User device 104 may include any of: user interface 106; application 108; user-initiated changes component 110; network-initiated changes component 112, network service API 127; network service 128; information source 116; other components; and any suitable combination of the foregoing.

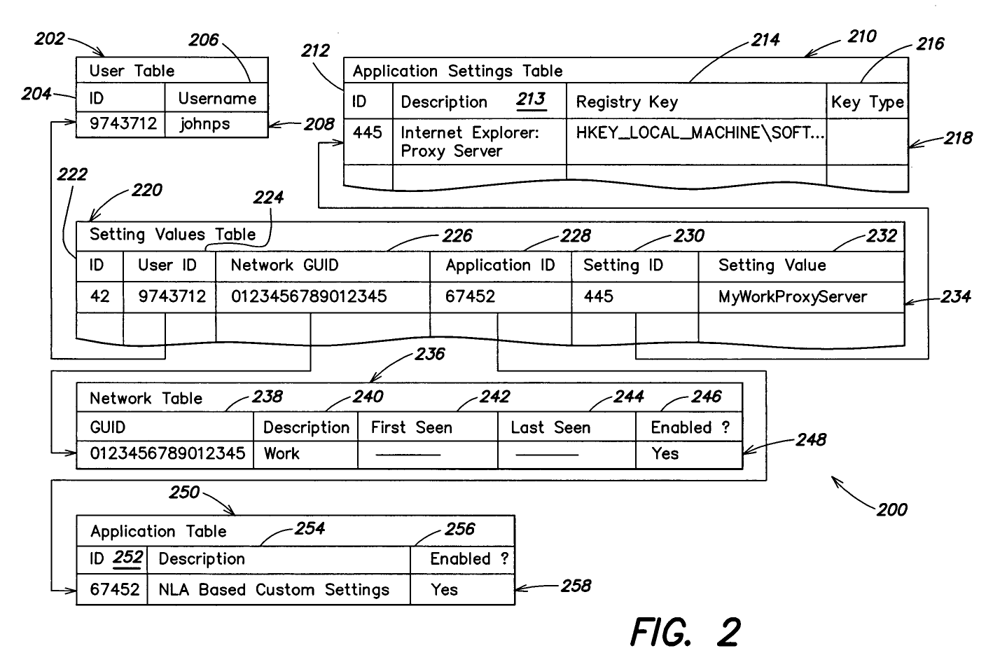

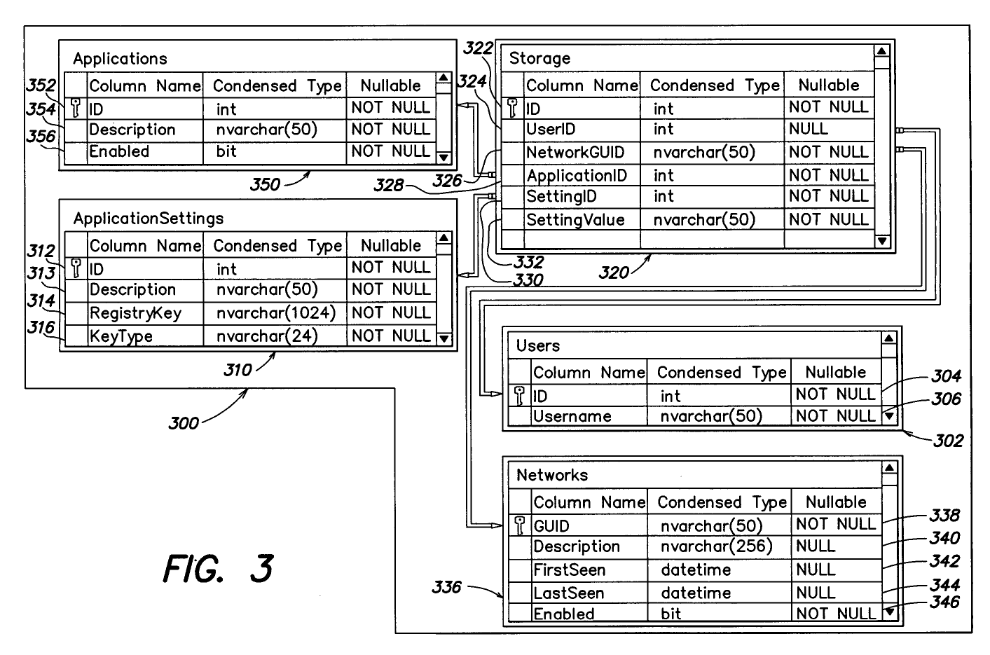

Information source 116 may be any of the plurality of types of data sources such as, for example, a database (e.g., an object-orientated database, relational database, multi-dimensional database, file system, other types of databases, or any suitable combination thereof). Information source 116 may include one or more application network setting values 118. For example, these values may be stored in one or more data structures, for example, one or more of the data structures described below in relation to FIGS. 2 and 3.

FIG. 2 is a block diagram illustrating an example of a database 200 for storing values of application settings for particular networks, according to some embodiments of the invention. Database 200 is merely an illustrative embodiment of a database for storing values of application settings for particular networks, and is not intended to limit the scope of the invention. Any of numerous other implementations of such data structures, for example, variations of database 200, are possible and are intended to fall within the scope of the invention. For example, although database 200 is shown as a relational database, other types of databases may be used such as, for example, an object-oriented database, a multi-dimensional database, a file system, another type of database, or any suitable combination of the foregoing.

Database 200 may include any of: user table 202; application settings table 210; setting values table 220; network table 236; application table 250; other tables; or any suitable combination of the foregoing. Each of the tables of database 200 may be defined in accordance with a table definition specified by a data structure of FIG. 3, and two or more (e.g., all) of these tables, or one or more columns and/or rows thereof, may be combined into a single table.

Digressing briefly from FIG. 2, FIG. 3 is a diagram illustrating an example of a database schema 300 for storing values of application settings for particular networks, according to some embodiments of the invention. Schema 300 is merely an illustrative embodiment of a schema for storing values of application settings for particular networks, and is not intended to limit the scope of the invention. Any of numerous other implementations of such a schema, for example, variations of schema 300, are possible and are intended to fall within the scope of the invention. For example, a schema for another type of database such as, for example, an object-oriented database, a file system, a multi-dimensional database, another type of database or any suitable combination of the foregoing may be used.

Schema 300 may include a plurality of data structures that define the tables of database 200. For example, data structures 302, 310, 320, 336 and 350 may define tables 202, 210, 220, 236 and 250, respectively.

Returning to FIG. 2, setting values table 220 may include a plurality of entries, and each entry may specify a value of an application setting for a particular network identifier such as, for example, a GUID. Setting values table 220 may include a plurality of columns including any of: ID column 22; user ID column 224; network GUID column 222; application ID column 228; setting ID column 230; setting value column 232; other columns; and any suitable combination of the foregoing. Columns 222, 224, 226, 228, 230 and 232 may be defined in accordance with column entries 322, 324, 326, 328, 330 and 332, respectively, of structure 320.

For each entry of table 220, ID column 222 may specify a unique identifier for the table entry. For example, entry 234 specifies the value “42” in the ID column. User ID column 224 may specify a user ID corresponding to an entry. For example, column 224 of entry 234 specifies “9743712” as a user ID. This user ID may serve as a key for an entry in user table 202.

User table 202 may include a plurality of entries, each entry corresponding to a user. Table 202 may include ID column 204 specifying a user ID and username column 206 for specifying a username. Columns 204 and 206 may be defined in accordance with column entries 304 and 306, respectively, of data structure 302. Entry 208 specifies a user ID of “9743712” and user name of “johnps”. Accordingly, entry 234 of table 220 is specific to the user having the username “johnps”. As entry 234 illustrates, in some embodiments of the invention, an entry of setting values table 220 (e.g., entry 234) may correspond to a specific user. This enables values for particular application settings, for example, those associated with a particular network identifier, to be defined for specific users. Accordingly, different users may have different values for a same application setting for a particular network. Further, one or more entries of table 220 may not include a user ID, indicating that the entry is common to all users; that is, the application setting for the particular network is the same for all users. For example, as defined by user ID column entry 324, the user ID column 224 of an entry may be left blank (i.e., “null”) such that an entry is applicable to all users.

Network GUID column 226 may specify a network GUID corresponding to an entry. For example, in entry 234, column 226 specifies a network GUID of “0123456789012345”. This network GUID may serve as a key for entry 248 of network table 236.

Network table 236 may include a plurality of entries (e.g., 248), each entry corresponding to a respective network. Each entry may include any of: a GUID column 238; a description column 240; a first seen column 242; a last seen column 244; an enable column 246; other columns; and any suitable combination of the foregoing. Columns 238, 240, 242, 244 and 246 may be defined in accordance with column entries 338, 340, 342, 344 and 346, respectively, of data structure 336.

For each entry, GUID column 238 may specify a GUID of a network, for example, “0123456789012345” in entry 248. It should be appreciated that any of a variety of other types of network identifiers may be used instead of a GUID for both column 238 of table 236 and column 226 of table 220, and are intended to fall within the scope of the invention.

Column 240 of each entry may specify a description (e.g., a name) of the network identified in column 238. For example, in entry 248, a network description of “Work” is specified in column 240, which may reflect that the user identifies this network as the user's work network.

Columns 242 and 244 may specify, for each entry, when the network corresponding to the entry was first seen and last seen, respectively, by the user device corresponding to database 200; that is, when the user device was first and last connected to the network and/or the first and last time a notification concerning the network ID of the network was received by the user device. As indicated by column entries 342 and 344 of data structure 336, columns 242 and 244 may be null for one or more entries such as, for example, entry 248, indicating that these values are not required for an entry.

Enable column 246 may specify for each entry whether the network corresponding to the entry is enabled for the user device. For example, in entry 248, column 246 indicates that the network is enabled.

Returning to table 220, the application ID column 228 of each entry may specify an identifier of an application corresponding to the entry. For example, in entry 234, an application ID of “67452” is specified. This value may serve as a key to entry 258 of application table 250.

Application table 250 may include a plurality of entries, including entry 258, each entry corresponding to an application. Each entry may include an ID column 252, a description column 254 and enable column 256, which may be defined in accordance with column entries 352, 354 and 356, respectively, of data structure 350. For each entry, ID column may specify the identification of an application such as, for example, “67452” of entry 258. Description 254 may provide a description of the application (e.g., a name of the application) such as, for example, “NLA Based Custom Settings” in entry 258. The enable column 256 may specify whether or not this particular application is enabled on a user device. Accordingly, column 256 may be configured to store a Boolean value such as, for example, “yes” as in entry 258, or “no.”

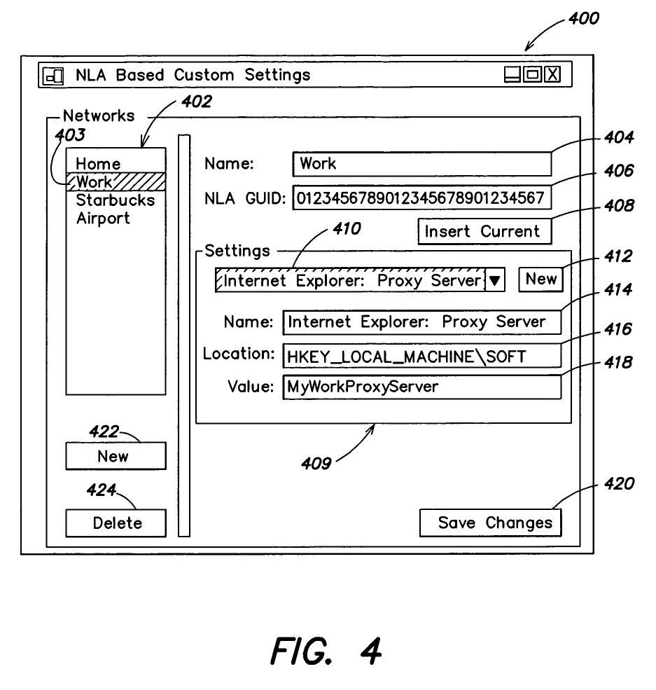

In some embodiments, the application specified in column 228 is a different application than the application for which the setting is specified in column 230. This is the case for entry 234 of table 220, and the user interface display 400 described below in relation to FIG. 4. In these examples, the application for adding, modifying and/or deleting an application setting value for a particular network is an application named “NLA Based Custom Settings” and the application of the setting is Internet Explorer. NLA Based Custom Settings may be an application that is independent of Internet Explorer, and may be configured to add, modify and/or cancel values for a plurality of applications.

In some embodiments, the application specified in Column 228 is the same application as the application for which the setting is specified in column 230. That is, the application configured to add, modify and/or delete the value of the application setting is the application of the setting itself. For example, the application Internet Explorer may be configured to enable a user to add, modify and/or delete the proxy server used by Internet Explorer for a particular network.

Returning to table 220, setting ID column 230 of each entry may specify an identifier of a setting corresponding to the entry. For example, column 230 of entry 234 specifies a setting ID of “445”. This setting ID may serve as a key to entry 218 of setting table 210.

Setting table 210 may include a plurality of entries, each entry corresponding to a particular setting. Each entry may include an ID column 212, a description column 213, a registry key column 214 and a key type column 216, which may correspond to column entries 312, 313, 314 and 316, respectively, of data structure 310. For each entry (e.g., entry 218), the ID column may specify an identifier (e.g., “445”) of a setting, and the description column 213 may specify a description (e.g., a name such as, for example, “Internet Explorer: Proxy Server”) of a setting.

Note that, in the example of entry 218, the description of the setting in column 213 includes a name of the application (“Internet Explorer”) as well as the name of the setting in the context of the application (“Proxy Server”). In some embodiments, column 213 only includes the name of the setting. For example, if the application specified in column 228 of table 220 (e.g., “Internet Explorer”) is the same as the application for which the setting is specified in column 230, then the name of the application can be gleaned from column 254 of table 250. In such a case, it would be redundant to include the name of the application in column 213 of table 210, such that column 213 may include only the name of the setting in the context of the application (e.g., “Proxy Server”).

In some embodiments of the invention, the user device corresponding to the database 200 may be configured with an operating system (e.g., one of the operating systems listed below available from Microsoft Corporation) that provides a registry (e.g., a Windows® registry) that stores values for various parameters (e.g., hardware and software parameters) of the user device. In such embodiments, registry key column 214 may specify a registry parameter corresponding to the setting identified in the entry, and key type column 216 may specify a type of the registration key specified in column 214. The application to which the setting specified by the entry belongs may be configured to use the registry parameter to determine/store a value of the setting for the application. Systems and methods described herein may change the value stored in the specified registry location, for example, based on a value stored in column 232 of table 220, so that the application uses the changed value. In some embodiments, column 214 may be configured to specify another type of location, other than a registry key, corresponding to the setting represented by the entry.

Returning to table 220, the setting value column 232 of an entry may specify a value of the setting identified in column 230 such as, for example “MyWorkProxyServer” in entry 234. Thus, based on the information provided in various tables of database 200, entry 234 of setting values table 220 specifies that, for user “johnps,” the value of the setting “Proxy Server” for application “Internet Explorer” for the “Work” network is “MyWorkProxyServer.” It should be appreciated that, although tables 202, 210, 220, 236 and 250 show only one entry, these tables may have a plurality of entries for various combinations of networks and application settings. Further, as described above, some of these entries may be defined to be specific to a particular user, while others may be generic to two or more users (i.e., not specific to a particular user).

Returning to FIG. 1, application 108 may be configured to be independent of user-initiated changes component 110 and network-initiated changes component 112, or may be configured to include or be integrated with one or both of these components. For example, application 108 may be developed such that components 110 and 112 are completely integrated within it, or components 110 and 112 may be independently developed and configured as an add-in to application 108. Further, components 110 and 112 may be configured to execute independently from application 108. User interface 106 may be configured to exchange user input/output 102 with a user. As used herein, a “user interface” is an application or part of an application (i.e., a set of computer-readable instructions) that enables a user to interface with an application during execution of the application. A user interface may include code defining how an application outputs information to a user during execution of the application, for example, visually through a computer screen or other means, audibly through a speaker of other means, and manually through a game controller or other means. Such user interface also may include code defining how a user may input information during execution of the application, for example, audibly using a microphone or manually using a keyboard, mouse, game controller, track ball, touch screen or other means.

The user interface may define how information is visually presented (i.e., displayed) to the user, and defines how the user can navigate the visual presentation (i.e., display) of information and input information in the context of the visual presentation. During execution of the application, the user interface may control the visual presentation of information and enable the user to navigate the visual presentation and enter information in the context of the visual presentation. Types of user interfaces range from command-driven interfaces, where users type commands, menu-driven interfaces, where users select information from menus, and combinations thereof, to GUIs, which typically take more advantage of a computer's graphics capabilities, are more flexible, intuitive and easy to navigate and have a more appealing “look-and-feel” than command-driven and menu-driven visual user interfaces. As used herein, the visual presentation of information presented by a user interface or GUI is referred to as a “user interface display” or a “GUI display,” respectively.

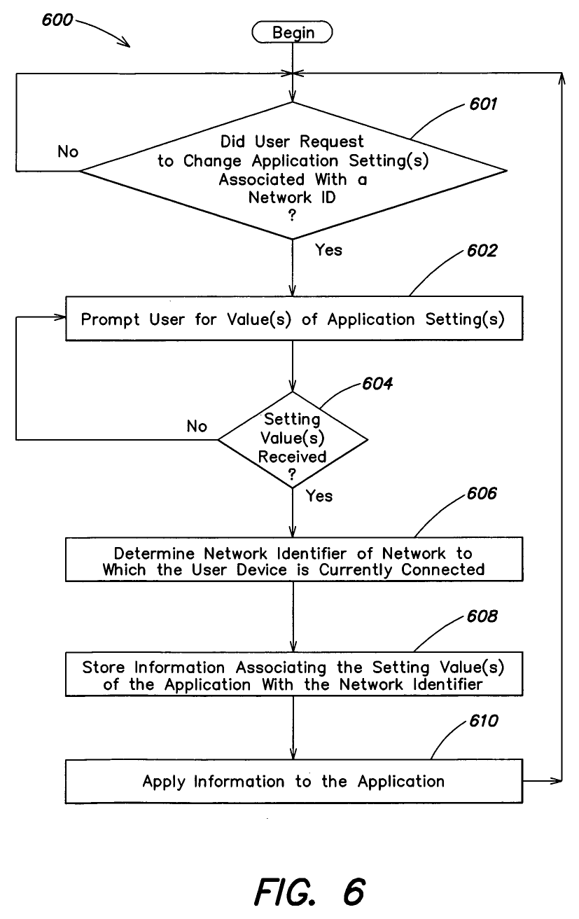

User-initiated changes component 110 may be configured to interact with user interface 106 to provide a user interface display that allows a user to add, modify and remove application network setting values 118 from information source 116 (e.g., database 200). For example, user-initiated changes component 110 may be configured to perform method 600, or one or more acts thereof, described below in relation to FIG. 6. User-initialed change component 110 (and network-initiated change component 112) may be configured to utilize network service API (e.g., NLA API) to use the network service 128. As used herein, an “application programming interface” or “API” is a set of one or more component-readable instructions that provide access to one or more other sets of computer-readable instructions that define functions, so that functions can be configured to be executed on a computer in conjunction with an application program. An API may be considered the “glue” between application programs in a particular computer environment or platform (e.g., any of those disclosed herein) and may enable a programmer to program applications to run on one or more particular computer platforms or in one or more particular computer environments.

In some embodiments, user-initiated changes component 110 may be capable of providing a user interface display such as display 400 shown in FIG. 4. Digressing briefly again from FIG. 1, FIG. 4 is a screen shot illustrating an example of a user interface display 400 for viewing, adding, modifying and/or deleting values of application settings for particular networks, according to some embodiments of the invention. Display 400 is merely an illustrative embodiment of a display for viewing, adding, modifying and/or deleting values of application settings for particular networks, and is not intended to limit the scope of the invention. Other implementations of such a display are possible, for example, variations of display 400, and are intended to fall within the scope of the invention.

Display 400 may include a network selection window 402 for selecting a network for which to set values of application settings. In the example of FIG. 4, a user selection 403 of a network named “Work” has been made.

Display 400 may include buttons 422 and 424 for adding and deleting, respectively, networks available on the user device. The networks displayed in window 402, and which may be added or deleted by buttons 422 and 424, may be those listed in network table 236 of network 200. For example, selected entry 403 may correspond to entry 248 of table 236.

In field 204, the name of the selected network (e.g., “Work”) may be displayed, and the network ID of this network may be displayed in field 406. For example, as illustrated in display 400, this network ID may be an NLA GUID, and may be the value specified in column 238 of the corresponding entry in network table 236, for example, entry 248.

Display 400 also may include a button 408 for selecting the current network to which the user device is connected, resulting in the name and network ID of this network being displayed in fields 404 and 406, respectively.

Display 400 may include a settings panel 409 for specifying values for one or more application settings for the network identified in fields 404 and 406. Settings panel 409 may include any of: setting selection field 410; new setting button 412; setting name field 414; setting location field 416; setting value field 418; other fields, buttons and/or controls; or any suitable combination of the foregoing.

Setting selection field 410 may enable a user to select a particular application setting available on the user device for which values may be set for a particular network. Field 410 may be a combobox or another type of field. The settings selectable through field 410 may be those settings for which an entry already exists in setting values table 220 for the network identified in fields 404 and 406; that is, those settings for which values have already been defined for the particular network. The value displayed in field 410 may be a description (e.g., a name) of the setting, for example, from description column 213 of the corresponding entry in settings table 210. In the example of display 400, the value displayed in field 400, “Internet Explorer: Proxy Server,” may be from column 213 of entry 218 of settings table 210. Entry 218 may have been determined based on the setting ID of column 230 of entry 234.

It should be appreciated that, in some embodiments such as the embodiment illustrated in FIG. 4, display 400 may not be configured to enable a user to specify an application independently from the setting itself. For example, the name of the setting may include the name of the application to which it applies as shown in field 414 (“Internet Explorer: Proxy Server”). Further, display 400 may only be provided for a particular application (e.g., it may be launched from within a particular application), such that specifying the application to which the setting applies would be redundant. Alternatively, display 400 may include one or more fields for selecting and/or specifying an application. For example, a user may be enabled to select and/or specify an application, and then specify/select one or more settings for that particular application for which to set values.

New button 412 may enable a user to define a value for an application setting for which no value has previously been defined for the particular network specified in fields 404 and 406.

Location field 416 may display a location at which the setting identified in field 414 is stored on the user device such as, for example, a location within a registry on the user device. As described above, this location may be the location used by the application to determine and/or store a value for an application setting. The value displayed in field 416 may correspond to the value of registry key column 214 for the setting identified in field 414. In the example of display 400, field 416 displays the value of column 214 of entry 218.

Value field 418 may display the value for the setting identified in field 414 for the network specified in fields 404 and 406. The value displayed in field 418 may correspond to the value stored in setting value column 232 of an entry of the setting values table 220. In the example of display 400, the value displayed in field 418 may correspond to the value stored in column 232 of entry 234.

Display 400 may be configured such that the user can enter and/or select values for field 418, thereby changing the value displayed in field 418. The value specified in field 418 may be a name of, or a pointer to, an object or other software abstraction available on the user device. For example, “MyWorkProxyServer” may be the name of an object available on the user device.

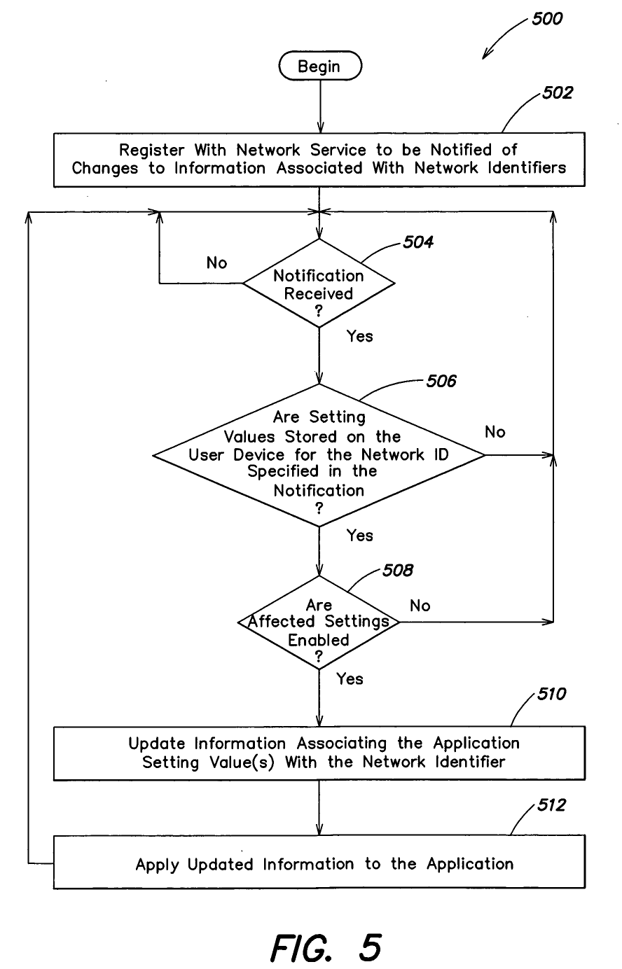

Returning to FIG. 1, network-initiated changes component 112 may be configured to add, modify and/or delete application network setting values 118 from information source 116 (e.g., database 200), for example, in response to changes to characteristics of communications network 120. In some embodiments, network-initiated changes component 112 may be configured to change values of application settings based on a change to network characteristics associated with a network ID such as, for example, a GUID. Network service 128 (e.g., an NLA server) may be configured to detect changes to network characteristics and/or exchange communications with other network device to determine such changes. Network service 128 may communicate such changes to network-initiated changes component 112 (e.g., through network service API 127), and network-initiated changes component 112 may be configured to make changes to one or more application network setting values 118 in response to such a communication. Network-initiated changes component 112 may be configured to implement method 500, and/or one or more acts thereof, described below in relation to FIG. 5.

Network service 128 may be a service configured in accordance with a Network Layer Awareness technology such as, for example, NLA. For example, network service 128 may be configured to listen for any network devices on network 120 that have connected or disconnected from network 120 and/or changed in some other fashion. When network service 128 detects network changes, it may update one or more application setting values 118, and may notify any applications which have registered to be notified. Network service 128 may be configured to track as many networks to which user device 104 is connected. If user device 104 has more than one network address, service 128 may recognize each address as being part of separate network having a separate GUID. Network service 128 may be configured to report to registered applications any changes associated with any of the multiple networks to which user device 104 belongs, for example, using a GUID as described herein.

System 100, and components thereof, may be implemented using any of a variety of technologies, including software (e.g., C, C#, C++, Java, or a combination thereof), hardware (e.g., one or more application-specific integrated circuits), firmware (e.g., electrically-programmed memory) or any combination thereof. One or more of the components of system 100 may reside on a single device (e.g., a computer), or one or more components may reside on separate, discrete devices. Further, each component may be distributed across multiple devices, and one or more of the devices may be interconnected.

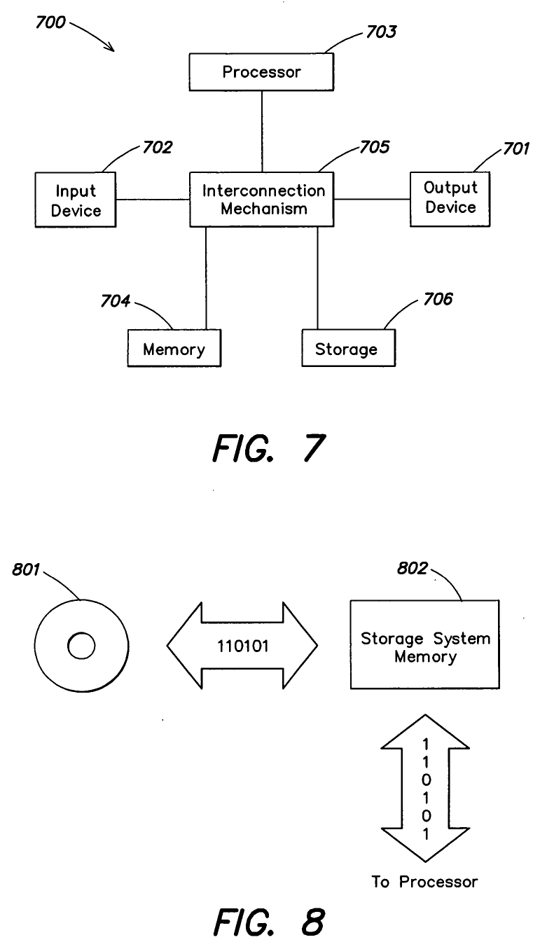

Further, on each of the one or more devices that include one or more components of system 100, each of the components may reside in one or more locations on the system. For example, different portions of the components of these systems may reside in different areas of memory (e.g., RAM, ROM, disk, etc.) on the device. Each of such one or more devices may include, among other components, a plurality of known components such as one or more processors, a memory system, a disk storage system, one or more network interfaces, and one or more busses or other internal communication links interconnecting the various components. System 100, and components thereof, may be implemented using a computer system such as that described below in relation to FIGS. 7 and 8.

FIG. 5 is a flow chart illustrating an example of a method 500 of modifying values of application settings based on changes associated with a network identifier, according to some embodiments of the invention. Method 500 is merely an illustrative embodiment of a method of changing values of application settings based on changes associated with a network identifier, and is not intended to limit the scope of the invention. Other implementations of such a method, for example, variations of method 500, are possible and are intended to fall within the scope of the invention.

In Act 502, an application on a user device may register with a network service on the user device to be notified of changes to information (e.g., network characteristics) associated with one or more network identifiers. For example, referring to FIG. 1, application 108 may register with network service 128 to receive notifications of changes to information associated with one or more network identifiers (e.g., GUIDs).

The application then may wait for a notification to be received, as illustrated by Act 504. It should be appreciated that although Act 504 of determining whether a notification is received is illustrated as an act occurring at a particular time during the sequence of method 500, the invention is not so limited. For example, method 500 may employ event-based programming and processing techniques, such that Act 504 is not affirmatively performed, but rather, method 500 is interrupted when a notification event occurs. Further, it should also be appreciated that during the performance of any of Acts 506-512 in response to receiving notification, another notification may be received. Acts 506-512 may be performed for this other notification in parallel to the performance of these acts for the previously received notification, or the other notification may be queued until processing resources are available to implement Acts 506-512.

If a notification is received from the network service, then, in Act 506, it may be determined whether there are any values stored on the user device for the network ID specified in the notification. For example, it may be determined whether there are any entries in setting values table 220 for a network identifier specified in the notification. If not, then method 500 may return to waiting for another notification.

If there are values stored on the user device for the network ID specified in the notification, then, in Act 508, it may be determined whether any of the application settings affected by the notification are enabled. For example, it may be determined whether the network ID and/or the application corresponding to the setting are enabled for the user device. This may be determined by checking column 256 of application table 250 for the application and/or checking column 246 of network table 236 for the network ID. If no settings are enabled, method 500 may return to waiting for a notification from a network service.

If it is determined that at least one of the settings specified in the notification is enabled, then, in Act 510, information on the user device may be updated accordingly, including updating information associating the application setting value(s) with the network identifier. For example, for each setting value, an entry corresponding to the network identifier and application setting may be updated in setting values table 220.

Further, in Act 512, for each changed setting, the updated information (e.g., changed setting value) may be applied to the affected application. For example, if the application is currently executing, values for the changed application settings may be changed in memory. Further, the value stored for the setting at the location identified in column 214 (e.g., the registry key) of application settings table may be changed to reflect the new value.

Method 500 may include additional acts. Further, the order of the acts performed as part of method 500 is not limited to the order illustrated in FIG. 5, as the acts may be performed in other orders and/or one or more of the acts may be performed in series or in parallel, at least partially. For example, as described above, method 500 may be performed using known event-based programming and processing techniques.

FIG. 6 is a flow chart illustrating an example of a method 600 of modifying values of application settings associated with a network identifier based on changes specified by a user, according to some embodiments of the invention. Method 600 is merely an illustrative embodiment of a method of modifying values of application settings associated with a network identifier based on changes specified by a user, and is not intended to limit the scope of the invention. Other implementations of method 600 are possible and are intended to fall within the scope of the invention. Method 600, or one or more acts thereof, may be performed using user interface display 400 described above in relation to FIG. 4.

In Act 601, it may be determined whether a user has requested to change one or more application settings associated with a network ID. For example, a user interface display of an application may present a field, button or other control that enables a user to request to make changes to application settings associated with the network ID. It should be appreciated that, in some embodiments, the user may not know the network ID or the network associated therewith, but may request to make changes to application settings associated with the current network ID. Although Act 601 is shown as occurring at a particular point within the sequence of acts of method 600, it should be appreciated that the invention is not so limited. For example, method 600 may be implemented using event-based programming and processing techniques. In such embodiments, rather than affirmatively performing Act 601, a user device or application may be interrupted by an event that makes the request specified in Act 601.

In Act 602, for one or more network settings, the user may be prompted for one or more values. For example, a user interface display may provide a field, button or other control that enables a user to enter and/or select application settings eligible to be changed.

After it has been determined that a setting value has been received from the user in Act 604, the network identifier of the network to which the user device is currently connected may be determined in Act 606. For example, the NLA GUID of the network to which the user device is connected may be determined by a network service (e.g., service 128).

As an alternative to performing Act 606, a user may specify and/or select the network for which one or more application settings will be modified, for example, as described above in relation to FIG. 4. Further, this act of specifying may be performed prior to Acts 602 and 604 of prompting and receiving one or more application setting values from the user. For example, a network identifier may first be entered/selected by the user, and then application setting values associated with the network identifier may be entered/selected by the user.

In Act 608, information associating the setting values of the application received from the user with the network identifier may be stored. For example, one or more pieces of such information may be stored in setting values table 220 and one or more other tables 202, 210, 236 and 250 of database 200.

In Act 612, the updated application information may be applied to the application, for example, as described above in relation to Act 510 of method 500.

Method 600 may include additional acts. Further, the order of acts performed as part of method 600 is not limited to the order illustrated in FIG. 6, as the acts may be performed in other orders and/or one or more of the acts may be performed in series or in parallel, at least partially. For example, as described above, method 600 may be performed using known event-based programming and processing techniques. Further, Act 606 may be performed prior to Acts 602 and 604.

Methods 500 and 600 acts thereof, and various embodiments and variations of these methods and these acts, individually or in combination, may be defined by computer-readable signals tangibly embodied on one or more computer-readable media, for example, non-volatile recording media, integrated circuit memory elements, or a combination thereof. Computer readable media can be any available media that can be accessed by a computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, other types of volatile and non-volatile memory, any other medium which can be used to store the desired information and which can accessed by a computer, and any suitable combination of the foregoing.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, wireless media such as acoustic, RF, infrared and other wireless media, other types of communication media, and any suitable combination of the foregoing.

Computer-readable signals embodied on one or more computer-readable media may define instructions, for example, as part of one or more programs, that, as a result of being executed by a computer, instruct the computer to perform one or more of the functions described herein (e.g., methods 500 or 600 or any acts thereof), and/or various embodiments, variations and combinations thereof. Such instructions may be written in any of a plurality of programming languages, for example, Java, J#, Visual Basic, C, C#, or C++, Fortran, Pascal, Eiffel, Basic, COBOL, etc., or any of a variety of combinations thereof. The computer-readable media on which such instructions are embodied may reside on one or more of the components of any of systems 100, 700 and 800 described herein, may be distributed across one or more of such components, and may be in transition therebetween.

The computer-readable media may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

It should be appreciated that any single component or collection of multiple components of a computer system, for example, the computer system described in relation to FIGS. 1, 2, 7 and 8, that perform the functions described herein can be generically considered as one or more controllers that control such functions. The one or more controllers can be implemented in numerous ways, such as with dedicated hardware and/or firmware, using a processor that is programmed using microcode or software to perform the functions recited above or any suitable combination of the foregoing.

Various embodiments according to the invention may be implemented on one or more computer systems. These computer systems, may be, for example, general-purpose computers such as those based on Intel PENTIUM-type processor, Motorola PowerPC, Sun UltraSPARC, Hewlett-Packard PA-RISC processors, any of a variety of processors available from Advanced Micro Devices (AMD) or any other type of processor. It should be appreciated that one or more of any type of computer system may be used to implement various embodiments of the invention.

A general-purpose computer system according to one embodiment of the invention is configured to perform one or more of the functions described above. It should be appreciated that the system may perform other functions and the invention is not limited to having any particular function or set of functions.

For example, various aspects of the invention may be implemented as specialized software executing in a general-purpose computer system 700 such as that shown in FIG. 12. The computer system 700 may include a processor 703 connected to one or more memory devices 704, such as a disk drive, memory, or other device for storing data. Memory 704 is typically used for storing programs and data during operation of the computer system 700. Components of computer system 700 may be coupled by an interconnection mechanism 705, which may include one or more busses (e.g., between components that are integrated within a same machine) and/or a network (e.g., between components that reside on separate discrete machines). The interconnection mechanism 705 enables communications (e.g., data, instructions) to be exchanged between system components of system 700. Computer system 700 also includes one or more input devices 702, for example, a keyboard, mouse, trackball, microphone, touch screen, and one or more output devices 701, for example, a printing device, display screen, speaker. In addition, computer system 700 may contain one or more interfaces (not shown) that connect computer system 700 to a communication network (in addition or as an alternative to the interconnection mechanism 705.

The storage system 706, shown in greater detail in FIG. 8, typically includes a computer readable and writeable nonvolatile recording medium 801 in which signals are stored that define a program to be executed by the processor or information stored on or in the medium 801 to be processed by the program. The medium may, for example, be a disk or flash memory. Typically, in operation, the processor causes data to be read from the nonvolatile recording medium 801 into another memory 802 that allows for faster access to the information by the processor than does the medium 801. This memory 802 is typically a volatile, random access memory such as a dynamic random access memory (DRAM) or static memory (SRAM). It may be located in storage system 706, as shown, or in memory system 704, not shown. The processor 703 generally manipulates the data within the integrated circuit memory 704, 802 and then copies the data to the medium 801 after processing is completed. A variety of mechanisms are known for managing data movement between the medium 801 and the integrated circuit memory element 704, 802, and the invention is not limited thereto. The invention is not limited to a particular memory system 704 or storage system 706.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 700 is shown by way of example as one type of computer system upon which various aspects of the invention may be practiced, it should be appreciated that aspects of the invention are not limited to being implemented on the computer system as shown in FIG. 7. Various aspects of the invention may be practiced on one or more computers having a different architecture or components that that shown in FIG. 7.

Computer system 700 may be a general-purpose computer system that is programmable using a high-level computer programming language. Computer system 700 also may be implemented using specially-programmed, special-purpose hardware. In computer system 700, processor 703 is typically a commercially available processor such as the well-known Pentium class processor available from the Intel Corporation. Many other processors are available. Such a processor usually executes an operating system which may be, for example, the Windows® 95, Windows® 98, Windows NT®, Windows® 2000 (Windows® ME) or Windows® XP operating systems available from the Microsoft Corporation, MAC OS System X available from Apple Computer, the Solaris Operating System available from Sun Microsystems, Linux available from various sources or UNIX available from various sources. Any of a variety of other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system, and that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems, and that the invention is not limited to any particular distributed architecture, network, or communication protocol.

Various embodiments of the present invention may be programmed using an object-oriented programming language, such as SmallTalk, Java, J# (J-Sharp), C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof. Further, various embodiments of the invention may be implemented using Microsoft®.NET technology available from Microsoft Corporation.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any equivalent means, known now or later developed, for performing the recited function.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method of configuring one or more settings of an application on a network device, wherein a data structure comprising one or more entries is stored on a computer-readable medium, at least a first entry defining a relationship between a value of a first setting of the application and a network identifier specifying a particular communications network, the setting representing a parameter of the network, the method comprising acts of:
(A) receiving a notification, from a network service on the network, the notification specifying the network identifier and specifying a change to a second setting associated with the network identifier, the second setting representing a same parameter as the first setting; and
(B) in response to receiving the notification, updating the value of the first setting of the first entry in accordance with the specified change.

2. The method of claim 1, further comprising an act of:
(C) prior to the act (A), registering the application to receive notifications from the network service of changes to values of settings associated with the network identifier.

3. The method of claim 1, further comprising acts of:
(C) providing a user interface enabling a user to specify a change of the value of the first setting of the application; and
(D) in response to the user specifying the change, updating the value of the first setting of the first entry in accordance with the specified change.

4. The method of claim 1, further comprising an act of:
(C) controlling the application to apply the value of the setting.

5. The method of claim 1, wherein the network identifier is a globally-unique identifier defined in accordance with a version of Network Layer Awareness technology.

6. The method of claim 5, wherein the first setting is an identification of a proxy server.

7. The method of claim 5, wherein the first setting is an identification of a firewall client.

8. A system for configuring one or more settings of an application on a network device, wherein a data structure comprising one or more entries is stored on a computer-readable medium, at least a first entry defining a relationship between a value of a first setting of the application and a network identifier specifying a particular communications network, the setting representing a parameter of the network, the system comprising:
a user-initiated changes component operative to enable a user to specify a change of the value of the first setting of the application, and to update, in response to the user specifying the change, the value of the first setting of the first entry in accordance with the specified change.

9. The system of claim 8, further comprising:
a network-initiated changes component operative to receive a notification from a network service on the network device, the notification specifying the network identifier and specifying a change to a second setting associated with the network identifier; the second setting representing a same parameter as the first setting, and to update, in response to receiving the notification, the value of the first setting of the first entry in accordance with the specified change.

10. The system of claim 9, wherein the network-initiated changes component is operative to register the application to receive notifications from the network service of changes to values of settings defined for the network identifier.

11. The system of claim 8, wherein the user-initiated changes component is operative to control the application to apply the value of the setting.

12. The system of claim 8, wherein the network identifier is a globally-unique identifier defined in accordance with a version of Network Layer Awareness technology.

13. The system of claim 12, wherein the first setting is an identification of a proxy server.

14. The system of claim 12, wherein the first setting is an identification of a firewall client.

15. A computer-readable medium having computer-readable signals stored thereon that define a data structure corresponding to a network device on a communications network, the data structure comprising at least a first entry defining a relationship between a value of a setting of an application and a network identifier specifying a particular communications network.

16. The computer-readable medium of claim 15, wherein at least the first entry comprises:
the network identifier;
an application identifier specifying the application;
a setting identifier specifying the setting; and
the value of the setting.

17. The computer-readable medium of claim 15, wherein the network identifier is a globally-unique identifier defined in accordance with a version of Network Layer Awareness technology.

18. The computer-readable medium of claim 17, wherein the setting is an identifier of a proxy server.

19. The computer-readable medium of claim 17, wherein the setting is an identifier of a firewall client.

20. The computer-readable medium of claim 15, wherein at least one of the entries comprises a user identifier specifying a user of the network device, such that the at least one entry only applies to the specified user.
